(19) United States
(12) Patent Application Publication
(10) Pub. No.: US 2010/0150680 A1
(43) Pub. Date: Jun. 17, 2010

(54) MILLING MACHINE DRIVE MECHANISM

(76) Inventor: BOR-HUAH CHERNG, Jiji Town (TW)

Correspondence Address: Dr. BANGER SHIA;Patent Office of Bang Shia, 102 Lindencrest Ct, Sugar Land, TX, 77479-5201, US

(21) Appl. No.: 12/334,741

(22) Filed: Dec. 15, 2008

(51) Int. Cl. B23Q 5/04; B23C 9/00

(52) U.S. Cl. 409/231

(57) ABSTRACT

The present invention provides a milling machine drive mechanism. The milling machine drive mechanism includes a main shaft, a gear assembly, and a machine shaft. The gear assembly includes a first gear and a second gear. The first gear is pin-jointed to the main shaft, so as to rotate with the main shaft. The second gear is operatively connected to the first gear. Wherein, the main shaft drives the second gear to rotate through the first gear. The main shaft is pin-jointed to the main shaft, so as to rotate with the second gear.

### BACKGROUND OF THE INVENTION

1. Field of the Invention

The invention is relative to a milling machine drive mechanism for milling a closed hole, and more particularly, the invention is relative to milling round and right angles. Processing the round and right angles by extending machine shaft, so as to reduce the complexity of the procedures and the difficulty in processing them.

2. Description of the Prior Art

A milling machine is a machine tool used for milling. The milling machine is also used for milling surfaces, grooves, gears, the threads of a screw, and pin keys. Additionally, it can process more complex shapes and it is more efficient than a planning machine. There are wide applications in machine manufacturing. A milling machine consists of a column, a work table, a knee, a main shaft, and an over-arm. The column is composed of hollow cast iron. There is a vertical precise dovetail rail on the column, so as to set the knee on it. The knee can move up and down vertically. The knee is also composed of cast iron wherein the two dovetail grooves perpendicular to each other are created in precise machine processing. The dovetail surface on the liquid surface of the knee is used to set the saddle. The saddle which is equipped with a horizontal table perpendicular to the liquid surface can move horizontally through a screw rod. The function of work table is to clip and fix a work piece, so as to mill the work piece. There is a T-slot on the work table used to clip the work piece, a pincer pliers, turntables, and so on. The main shaft is equipped in a bearing hole of the column, and the end of the main shaft is a taper hole used to set the milling shaft. Over-arm is set on the top of the column perpendicular to the surface of the cross rail and parallel to the milling shaft.

There are various kinds of milling machines. Milling machines are classified according to the layout and the applicable scope. The milling machines are classified as knee-type milling machines and planer-type milling machines. The knee-type milling machines include universal milling machines, horizontal milling machines, and vertically milling machines for processing middle-size and small-size components. Planer-type machine includes planer type milling-boring machines, planomilling machines and double-column planer milling machines are for processing large-sized components.

As shown in FIG. 1, FIG. 1 illustrates a conventional horizontal milling machine. The conventional horizontal milling machine includes a column 10, a work table 12, a knee 14, a main shaft 16, and an over-arm 18. A horizontal milling machine is the widest application processing machine. The principle of the horizontal milling machine is that the knife shaft is set on the main shaft of the column and the mill is set into the knife shaft. The work table can move up and down, right and left. The conventional milling machine is used to milling surfaces, grooves, round angles, gears, sprocket wheel, straddle milling and gang milling.

However, the present milling machine or the present mill can't mill round and right angles in one procedure. The general horizontal milling machine is used to milling huge surface or for a rough embryo, and the accuracy is not good. It takes a plurality of procedures to finish job. Even the highest Computer Numerical Control machine center also needs to collocate with other machines, for example, EDM (electric discharge machine) due to the knife head of CNC is too large to mill a rectangular surface of a complete hole. Using an EDM takes longer time to process and loses a lot of electricity. Besides, adding the procedures will add the magnitude of cumulative tolerance and takes a lot of time in the processing, which is a waste of time and the cost.

Therefore, the present milling machine and other processing machine can not be in the same machine to mill round and right angles. Thus, an aspect of the invention provides a milling machine drive mechanism which is for processing a complete hole, so as to mill a vertical surface of a right angle. Particularly, the milling machined drive mechanism of the present invention uses an extending machine shaft to process a round and right angle in one procedure without changing any knife or any machine. Thereby, it can produce a large number in a short time and reduces the cumulative tolerance in processing. Additionally, according to the result of the present invention, the machine shaft diverges from the main shaft through the gear paralleled, so as to be driven by the gear. Therefore, the machine shaft is extendable to prevent the main shaft from colliding with the work piece.

### SUMMARY OF THE INVENTION

An aspect of the invention is to provide a milling machine drive mechanism. The milling machine drive mechanism includes a main shaft, a gear assembly, and a machine shaft. The gear assembly includes a first gear and a second gear. The first gear is pin-jointed to the main shaft, so that it can rotate with the main shaft. The second gear is operatively connected to the first gear. Wherein, the main shaft drives the second gear to rotate through the first gear. The main shaft is pin-jointed to the main shaft, so that it can rotate with the second gear.

The milling machined drive mechanism of the present invention uses an extending machine shaft to process a round and right angle in one procedure without changing any knife or any machine. Thereby, it can produce a large number in a short time and reduces the cumulative tolerance in processing. Additionally, according to the result of the present invention, the machine shaft diverges from the main shaft through the gear paralleled, so that it can be driven by the gear. Therefore, the machine shaft is extendable, so as to prevent the main shaft from colliding with the work piece.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a conventional horizontal milling machine.

FIG. 2 illustrates a milling machine drive mechanism 20 of a horizontal milling machine 2 according to the preferred embodiment of the present invention.

FIG. 3 illustrates the milling machine drive mechanism 20 according to the preferred embodiment of the present invention.

FIG. 4 illustrates top view of the clip assembly according to the milling machine drive mechanism 20 of the present invention.

FIG. 5A illustrates top view of processing the complete hole 40 according to a conventional vertical milling machine.

FIG. 5B illustrates top view of processing the right angle surface of the complete hole 42 through the milling machine drive mechanism 20 of the milling machine 2 of the present invention.

FIG. 5C illustrates a perspective drawing of processing the round angle surface of the complete hole 44 through the milling machine drive mechanism 20 of the milling machine 2 of the present invention.

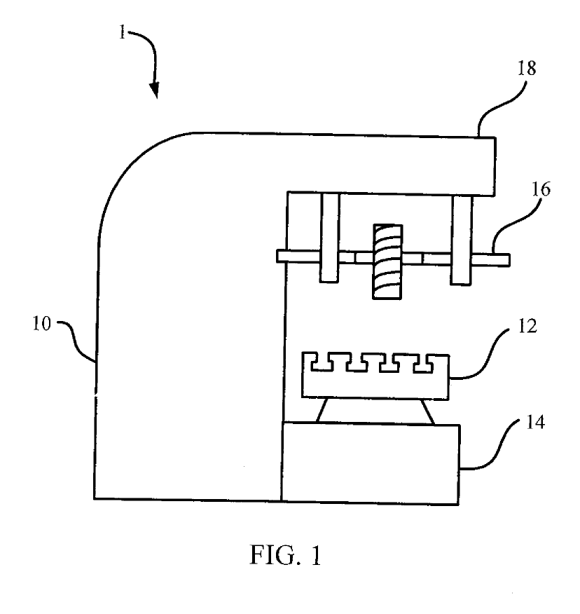

### DETAILED DESCRIPTION OF THE INVENTION

An aspect of the invention provides a milling drive mechanism for processing a complete hole to mill the vertical surface and round surface of a right angle. A gear assembly and cutters are fixed by a clip member. The machine shaft parallel diverges from the mail shaft. Round and right angles of a processing hole can be created in a short time without changing machines. Thus, it can produce a lot of components in a short time and to reduce the cumulative tolerance. The objective of the present invention will no doubt become obvious to those of ordinary skill in the art after reading the following detailed description of the preferred embodiment.

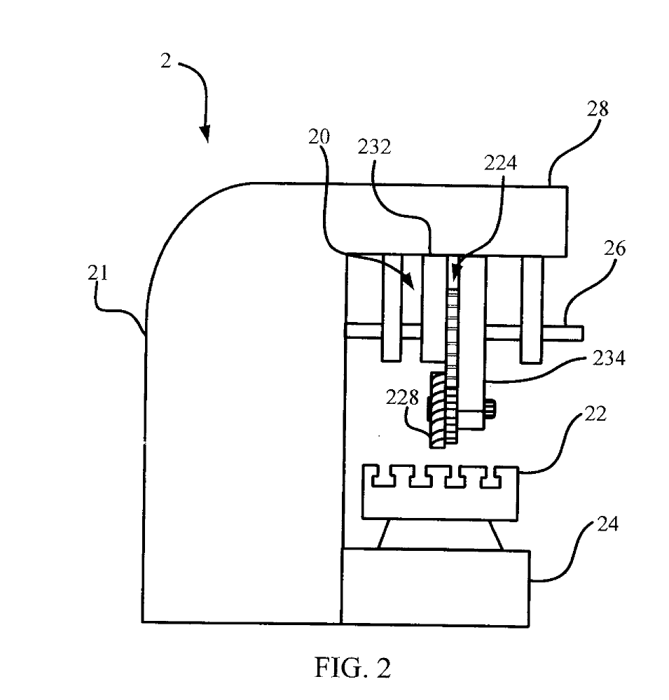

Please refer to FIG. 2. FIG. 2 illustrates a milling machine drive mechanism 20 of a horizontal milling machine 2 according to the preferred embodiment of the present invention. In the preferred embodiment, the milling machine comprises a column21, a work table 22, a knee 24, an over-arm 28, and a milling drive mechanism 20. The milling machine mechanism 20 comprises a main shaft 26, a gear assembly 224, and a machine shaft 226. The main shaft 26 can be driven by a motor of the milling machine. The gear assembly 224 comprises a first gear 2242 and a second gear 2244. The first gear 2242 is pin-jointed to the main shaft 26 and rotates with the main shaft 26. The second gear 2244 is operatively connected with the first gear 2242 wherein the main shaft 26 drives the second gear 2244 to rotate through the first gear 2242. The machine shaft 226 can be pin-jointed to the second gear 2244, so as to rotate with the second gear 2244. The second gear 2244 and the first gear 2242 can rotate in mesh. The milling machine drive mechanism 20 according to the preferred embodiment of the present invention is described in details in the following description comprising the function and work mode.

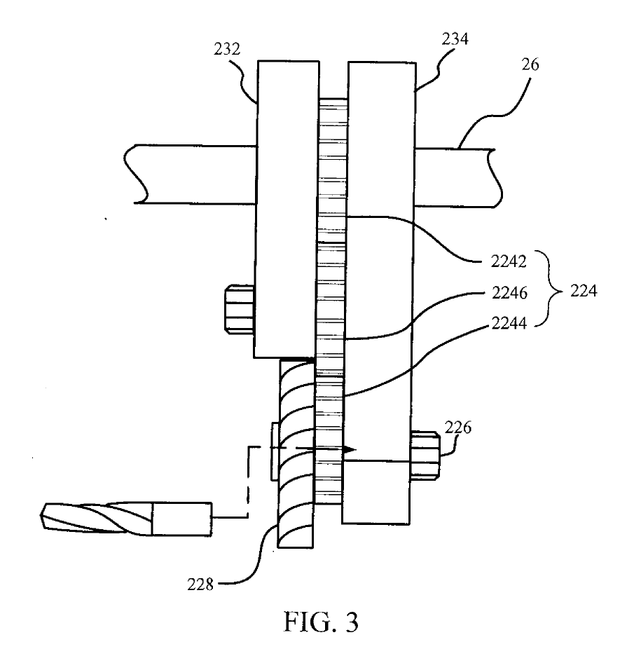

Please refer to FIG. 3. FIG. 3 illustrates the milling machine drive mechanism 20 according to the preferred embodiment of the present invention. As shown in FIG. 3, the gear assembly 224 further comprises a third gear 2246, which is engaged with the first gear and the second gear respectively. In practical application, if the number of the teeth on gear assembly 224 is an odd number, the rotation direction of the gear and the main shaft are the same. Additionally, the number of the teeth affects the ratio of revolving speed. The so called revolving speed ratio means the ratio of teeth number on different gears. When the ratio of revolving speed is higher, so is the cutting speed. While the ration of revolving speed is lower, then the cutting stress is greater. It is adopted selectively according to the practical application.

Additional remarks, the surface of work piece varies with the rotation direction of the mill in processing. If the forward direction of the work piece is the same to the rotation direction of the mill, it is called climb milling or down milling. If the forward direction of the work piece is opposite to the rotation direction of the mill, it is called conventional milling or up milling.

At the beginning of milling, there is a maximum milling thickness in down milling process and the milling thickness reduces gradually to prevent the milling from being processed on the cold hard processed surface, and it is more efficient to mill a material which is hard to mill. Horizontal component force of each gear tooth is opposite to the forward direction and thus the screws and nuts are on the left side of the work table, so as to present a gap on the right side. The work table will vibrate unevenly. In a serious condition, the blade of a mill can break. Up milling is adopted for rough processing or processing a work blank with hard face. During precise processing, the force of milling is small and the work table does not vibrate much, so the down milling adopted.

As shown in FIG. 3, the machine shaft is pin-jointed to the mill 228, so as to rotate with the machine shaft 226 paralleled to the main shaft 26. Additionally, the mill 228 can be an end mill, a plain milling cutter, a plain spiral milling cutter, slitting saw milling cutter, a side milling cutter, bevel milling cutter, and a face mill, but not limited to these. It is adopted selectively according to practical application. In practical application, the mills are classified according to the purposes. For example, a plain milling is selected to mill a surface parallel to the knife shaft. The side cutter is selected to mill a groove, a surface, and straddle milling; and the slitting saw milling is selected to slit or saw a work piece.

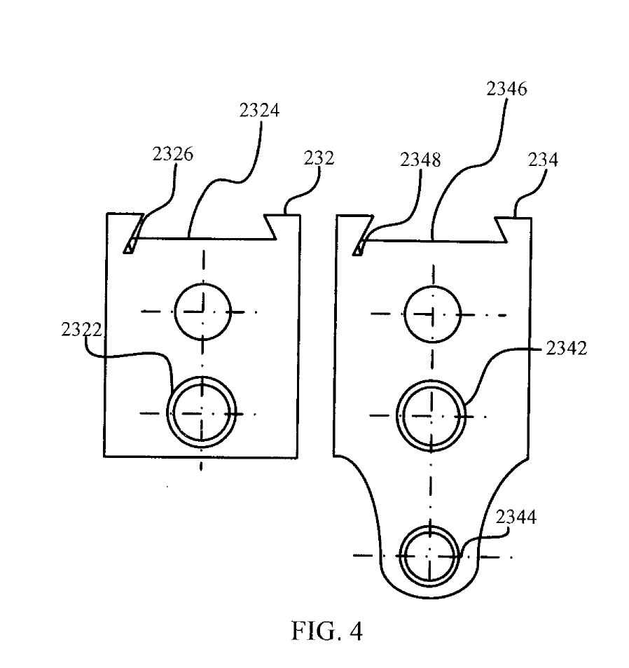

Please refer to FIG. 4 and FIG. 3. FIG. 4 illustrates top view of the clip assembly according to the milling machine drive mechanism 20 of the present invention. As shown in FIG. 4 and FIG. 3, the clip assembly comprises a first clip member 232 and a second clip member 234. The first clip member 232 is set on one side of the first gear 2242 and the second clip member 234 is set on the other side of the first gear 2242 wherein the machine shaft 226 is pivoted on the second clip member 234. Additional remarks, the first gear 2242 and the third gear 2246 are rotated and engaged with the third gear between the first clip member 232 and the second clip member 234; and the second gear 2244 is rotated and engaged with the second clip member 234.

The first clip member 232 and the second clip member 234 are screwed together. In practical application, the first member 232 and the second clip member 232 can be pin-jointed together or screwed by a bolt to fix, but not limited to these. Furthermore, the first clip member 232 is engaged with the third gear 2246 through the first bearing 2322; the second clip member 234 is engaged with the third gear 2246 through the second bearing 2342; and the second clip member 234 is engaged with the second gear 2244 through the third gear bearing 2344. The first bearing 2322, the second bearing 2342 and the third bearing 2344 are all ball bearings. Additional remarks, a ball bearing can be a ball centripetal thrust bearing or a ball thrust bearing, but not limited to them.

Furthermore, the clip assembly of the present invention further has two engaging portions wherein the first clip member 232 has a first engaging portion 2324. The first clip member 232 is engaged with the over-arm 28 of the milling machine through the first engaging portion 2324, and the second clip member 234 is engaged with the over-arm 28 of the milling machine through the second engaging portion 2346. Particularly, the first engaging portion 2324 and the second engaging portion are dove-tail grooves.

As shown in FIG. 4. The first clip member 232 comprises a first hole 2326 paralleled to the main shaft 26. The first hole 2326 connects with the first engaging portion 2324 by way of wire cutting. The second clip member 234 comprises a second hole 2348 substantially paralleled to the main shaft 26 wherein the first hole 2326 and the second hole 2348 can reduce shear stress created by the main shaft 26 in cutting process.

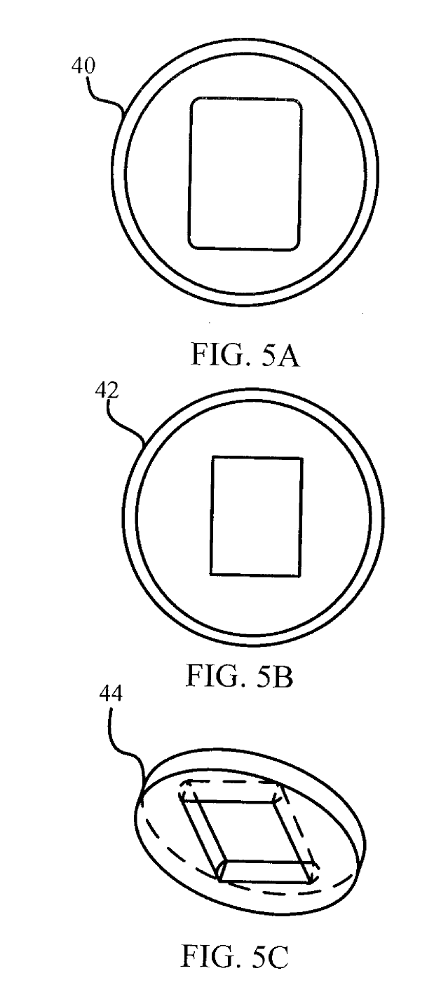

Please refer to FIG. 5A, FIG. 5B, and FIG. 5C. FIG. 5A illustrates a top view of processing the complete hole 40 with a conventional vertical milling machine. FIG. 5B illustrates a top view of processing the right angle surface of the complete hole 42 through the milling machine drive mechanism 20 of the milling machine 2 of the present invention. FIG. 5C illustrates a perspective drawing of processing the round angle surface of the complete hole 44 through the milling machine drive mechanism 20 of the milling machine 2 of the present invention. As shown in FIG. 5A, a traditional processing machine does not process a right angle in the complete hole 40. As shown in FIG. 5B, the milling machine drive mechanism of the present invention can collocate with dividing heads to process an inner hole with right angles. Furthermore, the invention can mill round angles as shown in FIG. 5C.

By detailed description of the preferred embodiment of the present invention, it is known that the milling machine drive machine of the present invention is applied to process a complete hole, so as to mill the vertical surface of a right angle. Large-size holes are processed by vertical milling machine, but the edge of a hole cannot be milled to form a right angle due to the shape of a mill. A conventional horizontal milling machine can easily wedge in a main shaft. Therefore the milling machine drive mechanism of the present invention is to fix a gear assembly and cutters by a clip member, so as the machine shaft parallel diverges from the mail shaft.

The round angle and right angle of a complete hole are milled in one single machine. Thereby, it takes a shorter time to process round and right angles and reduces the cumulative tolerance. Additionally, according to the result of the present invention, the machine shaft parallel diverges from the main shaft through the gear and is driven by the gear. Therefore, the machine shaft is extendable, so as to prevent the main shaft from colliding with the work piece.

Although the present invention has been illustrated and described with reference to the preferred embodiment thereof it should be understood that it is in no way limited to the details of such embodiment but is capable of numerous modifications within the scope of the appended claims.

What is claimed is:

1. A milling machine drive mechanism set in a milling machine, the milling machine drive mechanism comprising:
a main shaft;
a gear assembly comprising:
a first gear pinpointed to the main shaft, so as to rotate with the main shaft; and
a second gear operatively connected to the first gear, and the main shaft driving the second gear to revolve through the first gear; and
a machine shaft pin-Jointed to the second gear, so as to rotate with the second gear.

2. The milling machine drive mechanism of claim 1, wherein the second gear engages with the first gear.

3. The milling machine drive mechanism of claim 1, wherein the gear assembly further comprises a third gear engaged with the first gear and the second gear respectively.

4. The milling machine drive mechanism of claim 3 further comprising:
a clip assembly comprising:
a first clip member set on one side of the first gear; and
a second clip member set on the other side of the first gear, wherein the machine shaft pivots on the second clip member;
wherein the first gear can be rotated and engaged with the third gear between the first clip member and the second clip member, and the second gear can be rotated and engaged with the second clip member.

5. The milling machine drive mechanism of claim 4, wherein the first clip member and the second clip member are screwed together.

6. The milling machine drive mechanism of claim 4, wherein the first clip member engages with the third gear through a first bearing; the second clip member engages with the third gear through a second bearing; and the second clip member engages with the second gear through a third bearing.

7. The milling machine drive mechanism of claim 6, wherein all of the first bearing, the second bearing, and the third bearing are ball bearings.

8. The milling machine drive mechanism of claim 4, wherein the first clip member has a first engaging portion, the first clip member engages with the milling machine through the first engaging portion; the second clip member has a second engaging portion, and the second clip member engages with the milling machine through the second engaging portion.

9. The milling machine drive mechanism of claim 8, wherein the first engaging portion and the second engaging portion are dove-tail grooves.

10. The milling machine drive mechanism of claim 8, wherein the first clip member comprises a first aperture substantially parallel to the main shaft and the first aperture connects with the first engaging portion; the second clip member comprises a second aperture substantially parallel to the main shaft, and the second aperture connects with the second engaging portion.

11. The milling machine drive mechanism of claim 10, wherein the first aperture and the second aperture connect with the first engaging portion and the second engaging portion respectively by way of wire cutting.

12. The milling machine drive mechanism of claim 1, wherein the machine shaft is pin-jointed to a mill, and the mill rotates with the machine shaft.

13. The milling machine drive mechanism of claim 1, wherein the machine shaft is parallel to the main shaft.
